(19) United States
(12) Patent Application Publication
(10) Pub. No.: US 2003/0172351 A1
(43) Pub. Date: Sep. 11, 2003

(54) Mark-up language conversion

(76) Inventor: Mohinder Singh Garcha, Middlesex (GB)

Correspondence Address: Edward A. Pennington, Esq., Swidler Berlin Shereff Friedman, LLP, Suite 300, 3000 K Street, N.W., Washington, DC, 20007-5116, US

(21) Appl. No.: 10/370,720

(22) Filed: Feb. 24, 2003

(30) Foreign Application Priority Data
Feb. 25, 2002 (GB) 0204357.8

(51) Int. Cl. G06F 15/00

(52) U.S. Cl. 715/513

(57) ABSTRACT

A method of converting text written in a first mark-up language and comprising a document file and a document type definition (DTD) file, to a second mark-up language which does not utilize a DTD file. The method comprises

i) scanning the DTD file to extract definitions;

ii) scanning the document file to locate cross-reference tags and to identify cross-referenced text; and,

iii) scanning the document file to locate successive blocks of text defined between respective start and end tags of the same type and, for each block, creating equivalent tags and text in the second mark-up language using, where necessary, the extracted definitions and cross-references from steps i) and ii).

### FIELD OF THE INVENTION

The invention relates to a method and apparatus for converting between different mark-up languages.

### DESCRIPTION OF THE PRIOR ART

Mark-up languages have been developed in recent years to enable text, graphics and the like to be handled by different output engines, the mark-up languages having a well defined structure which can be analysed and converted to a local output format as required. Commonly, when constructing documents, SGML (Standard Mark-Up Language) is used to define the document. The format of SGML is supported by International Standards originating with IS08879. In its basic form, an SGML document contains three major parts:

SGML declaration

Document Type Declaration

Tagged document instance

The SGML declaration sets out the SGML rules of the current document: the character set, characters used as control characters, and which SGML features can be used in the document, among other items. Common SGML features include tag minimization, short names for tags, use of multiple DTDs in one document.

The Document Type Declaration sets out which DTD (Document Type Definition) governs the current document. It explains:

What are the element's contents?

Which elements are required? In what order?

Is the end tag required or optional?

Are the attributes required or optional?

Do they have a default value?

The document Instance contains marked up document contents, markers, usually called tags, being enclosed with angled brackets.

A particular advantage of SGML is that it is platform independent and it also enables the use of PIDs (Persistent Ids) to identify the different elements within the document when carrying out tasks such as language translation. Using PIDs avoids duplicate translations and reduces time and cost. Thus, PIDs provide the tracking mechanism which allow translation groups to automatically update unchanged paragraph text between product releases, only translating what has changed or new text. Associating PIDs with each paragraph makes it more cost effective and time-efficient for translation as there is less overhead and cost allocated to retranslating existing unchanged material.

More recently, other mark-up languages have been developed such as HTML (Hyper Text Mark-Up Language) which has a rather simpler structure and is often used in certain applications where the complexities of SGML are not required.

We have found there is a need in some circumstances to be able to convert a document represented in SGML to HTML and at present the process used is very time consuming. This known process is based upon Microsoft Word® with additional macros and can take up to two days to convert SGML to HTML.

### SUMMARY OF THE INVENTION

In accordance with a first aspect of the present invention, a method of converting text written in a first mark-up language and comprising a document file and a document type definition (DTD) file, to a second mark-up language which does not utilize a DTD file comprises:

i) scanning the DTD file to extract definitions;

ii) scanning the document file to locate cross-reference tags and to identify cross-referenced text; and,

iii) scanning the document file to locate successive blocks of text defined between respective start and end tags of the same type and, for each block, creating equivalent tags and text in the second mark-up language using, where necessary, the extracted definitions and cross-references from steps i) and ii).

In accordance with a second aspect of the present invention, apparatus for converting text written in a first mark-up language and comprising a document file and a document type definition (DTD) file to a second mark-up language which does not utilize a DTD file comprises a processor for performing the steps of a method according to the first aspect of the invention.

We have analysed the structure of certain mark-up languages such as SGML and found that by suitably structuring the conversion or parsing processing, it is possible to achieve very rapid conversion (for example just a few minutes to convert to HTML instead of days). This involves first extracting definition and cross-reference information and then operating on each block of text utilizing the previously extracted definition information.

The invention is particularly suitable for converting SGML to HTML but could be used for converting other mark-up languages including SGML to XML.

Preferably, step iii) comprises detecting in the block of text any definitions, such as keywords, previously identified from the DTD file in step i); and creating text in the second mark-up language in accordance with the definition.

Of course, a typical DTD file will contain other definitions such as the hierarchy of elements within the graphical definitions, which can also be obtained in step i) for future use.

In the preferred method, step ii) comprises:

a) scanning the original text to identify each cross-reference identifier and storing a list of cross-reference identifiers; and then

b) scanning the original text to locate definitions for each identified cross-reference identifier in the list and storing each definition so that it is indexed by the corresponding cross-reference identifier.

This preparatory step enables the text subsequently to be rapidly converted from one mark-up language to the other since whenever a cross-reference identifier is found, it can be quickly replaced with the corresponding pre-stored definition, typically a text string or the content of a file.

An example of a method and apparatus according to the invention will now be described with reference to the accompanying drawings, in which:—

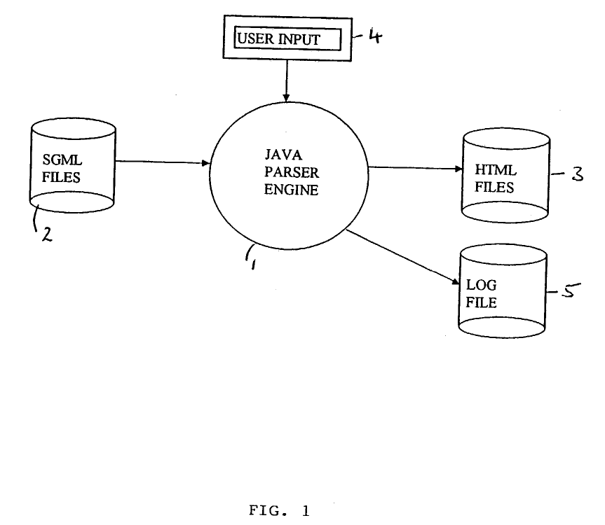

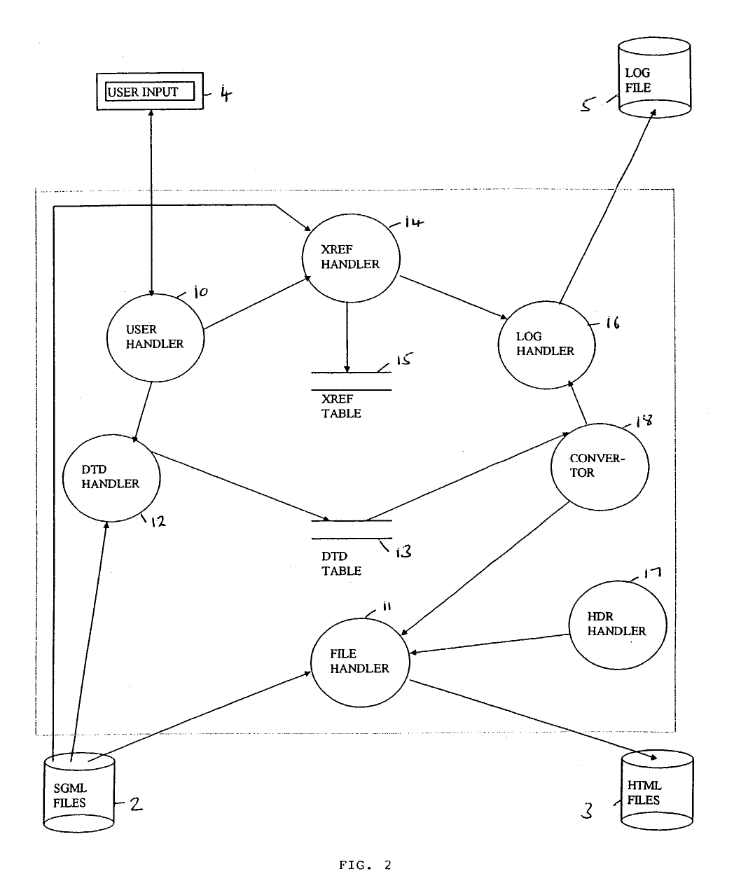

FIG. 1 is a block diagram of the apparatus;

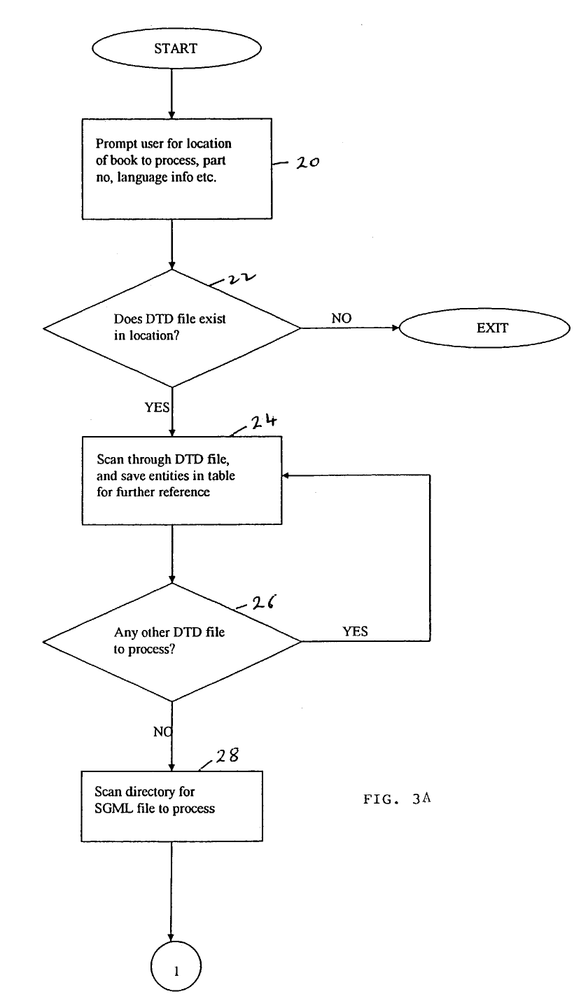

FIG. 2 is a block diagram illustrating the main components of the parser; and,

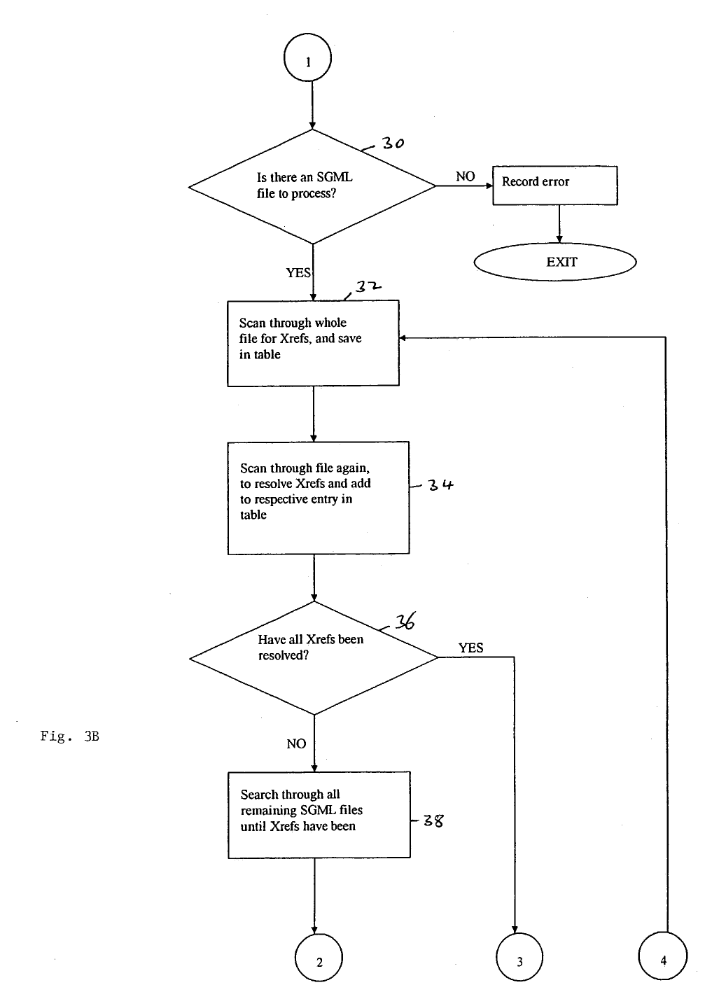

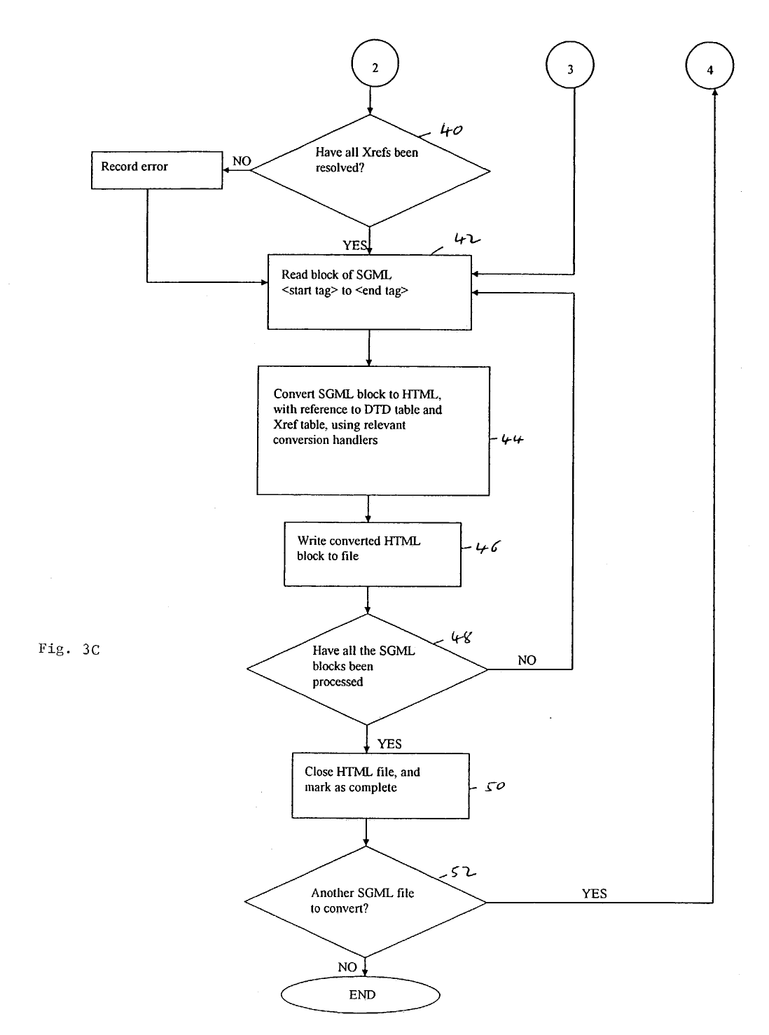

FIGS. 3a, 3b, and 3c together are a flow diagram illustrating operation of the parser.

An example of an SGML document instance together with the corresponding converted HTML is set out in the Appendix and the following discussion will refer to that example.

The apparatus can be implemented in a variety of forms of which that shown in FIG. 1 is just one example.

In this example, a microprocessor 1 defining a Java Parser Engine is coupled with a store 2 for storing an original SGML file set which will include the conventional parts of an SGML document as set out earlier. The

The apparatus can be implemented in a variety of forms of which that shown in FIG. 1 is just one example.

In this example, a microprocessor 1 defining a Java Parser Engine is coupled with a store 2 for storing an original SGML file set which will include the conventional parts of an SGML document as set out earlier. The converted HTML file will be stored in a store 3. A user input device (e.g. mouse) 4 is provided along with a log file 5.

The method will be typically implemented in Java.

FIG. 2 illustrates in more detail the organisation of the parser, each bubble in FIG. 2 representing one or more Java Objects. The primary components therefore include a user handler object 10 for prompting users for the location of a book to process, languages, part numbers and the like. A file handler 11 checks for the existence of DTD/SGML files and creates HTML dir.\files. A DTD handler object 12 processes the DTD file and saves the processed information in a DTD table 13 in memory. A XREF handler object 14 processes cross references for each file and saves the information in a XREF table 15 in memory. A log handler object 16 adds messages during processing, such as progress of conversion, and errors to the log file 5.

A header/trailer handler object 17 adds the header and trailer to the resultant HTML file while a convertor object 18 provides the primary SGML/HTML block conversion processing.

FIG. 3 illustrates in flow diagram form the operation of the parser of FIG. 2.

Initially, an SGML document is stored in the store 2 and this may have been generated in any conventional manner but will be constituted by an SGML declaration, a DTD, and the document instance and in step 20, the user is asked for the location of the file. DTD handler 12 checks the DTD file exists (step 22) and if it does, analyses (step 24) each line in that file to produce an interpretation of the line which is stored in the table 13. This is repeated (step 26) for any other DTD files.

For example, the two lines of the DTD shown below (which correspond to the SGML in the Appendix) will be used to replace text in the SGML file, and then of course passed to the HTML file.

<!ENTITY product-AOL.IIM-00002350 CDATA “Application Object Library”>

<!ENTITY product-OPSFI.IIM-00002335 CDATA “Oracle Public Sector Financials (International)”>

There will be many lines in the DTD. Each line is read by the DTD handler 12, and stored, for use later in processing the SGML file. Each line is interpreted depending upon it's type (above is CDATA, but it could be SYSTEM, NDATA or others). The above two lines are interpreted as replace any text field prior to keyword CDATA, but after !ENTITY with text after CDATA.

So for the first line:—If a line of text is seen in the SGML document as:

&product-AOL.IIM-00002350

it will be replaced by

‘Application Object Library’ (without the quotes)

The ampersand is used to signify that text needs modification (which in this case is simple replacement.

Next, the XREF handler 14 locates (steps 28,30) and reviews the document instance (SGML file) to deal with cross-references. (Step 32).

The cross-references are processed in the following manner:

For each SGML file, scan through, search and save in the table 15 a list of Xrefs to resolve (essentially search for keyword “<Xref Linkend=xxxxx”). Then scan the file again (step 34) to resolve (i.e. find the id for the xref) Xrefs for the list created earlier. This is essentially looking for “id=xxxxx”. These values of text, table or figure are saved to the relevant item in the list in the table 15.

The example below explains this:

First scan of file will save identifier “IAOLSETPREQ” from line in file thus “<XRef Linkend=“IAOLSETPREQ”

Second scan of file will resolve “IAOLSETPREQ” from the following line:—

Section PageBreak=“DoNotForcePageBreak” Id=“IAOLSETPREQ”

LinkTarget=“iaolsetpreqx”><Head><?PID IIM-00007630>Prerequisites

Notice the keyword “id” and the identifier “IAOLSETPREQ” appear here. This time the xref is resolved to a section heading, which in this case is “Prerequisites”

This will be one item which will be saved internally by the parser together with others as:

IAOLSETPREQ Prerequisites

Now when the parser converts to HTML, it will replace any ref to “IAOLSETPREQ” with “Prerequisites” or rather

“<A HREF=”@IAOLSETPREQ#IAOLSETPREQ“>Prerequisites</A>”

as it would appear in the file. When viewed through the web browser this would appear as blue text, signifying a reference.

If there are any remaining cross-references to be resolved for the current files (step 36), the parser then searches all remaining SGML files (step 38) until all cross-references have been resolved (step 40).

Having analysed the DTD file and cross-references, the convertor 18 is then ready to convert blocks of SGML text in the document instance to HTML. Thus the convertor reads a block of HTML (step 42), converts that block to HTML (step 44) and then stores the HTML in the store 3 (step 46)

During step 44, in most cases an SGML tag can be replaced by a corresponding HTML tag and there is also one-to-one correspondence between text and other items between tags in the block. However, where an SGML element has been identified earlier within the DTD or as a cross-reference then the conversion will utilize the real meaning of the element in place of the element.

In order to enable back conversion to SGML, the HTML file retains the required text as comments between symbols <- - . . . . - - > as can be seen in the Appendix.

The parser then checks that all the SGML blocks have been processed (step 48) and if not, steps 42-46 are repeated. Otherwise, the HTML file is closed and marked as completed (step 50) and if there is no further SGML file to convert (step 52), the process stops.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROMs, as well as transmission-type media, such as digital and analog communications links.

[image]

[image]

I claim:

1. A method of converting text written in a first mark-up language and comprising a document file and a document type definition (DTD) file, to a second mark-up language which does not utilize a DTD file, the method comprising:
i) scanning the DTD file to extract definitions;
ii) scanning the document file to locate cross-reference tags and to identify cross-referenced text; and,
iii) scanning the document file to locate successive blocks of text defined between respective start and end tags of the same type and, for each block, creating equivalent tags and text in the second mark-up language using, where necessary, the extracted definitions and cross-references from steps i) and ii).

2. A method according to claim 1, wherein the first mark-up language comprises SGML and the second mark-up language comprises HTML.

3. A method according to claim 1, wherein step iii) comprises detecting in the block of text any definitions, such as keywords, previously identified from the DTD file in step i); and creating text in the second mark-up language in accordance with the definition.

4. A method according to claim 1, wherein step ii) comprises:
a) scanning the original text to identify each cross-reference identifier and storing a list of cross-reference identifiers; and then
b) scanning the original text to locate definitions for each identified cross-reference identifier in the list and storing each definition so that it is indexed by the corresponding cross-reference identifier.

5. Apparatus for converting text written in a first mark-up language and comprising a document file and a document type definition (DTD) file to a second mark-up language which does not utilize a DTD file, the apparatus comprising a processor for performing the steps of a method according to any of the preceding claims.
